(19) United States
(12) Patent Application Publication
(10) Pub. No.: US 2025/0126408 A1
(43) Pub. Date: Apr. 17, 2025

(54) COMPOSITE DIAPHRAGM AND SOUND-GENERATING DEVICE

(71) Applicant: AAC Microtech (Changzhou) Co., Ltd., Changzhou (CN)

(72) Inventors: Zhongwei Wang, Changzhou (CN); Xiaoman Hou, Changzhou (CN); Jiong Xie, Changzhou (CN); Ronglin Linghu, Changzhou (CN); Hongyuan Wang, Changzhou (CN)

(21) Appl. No.: 18/540,944

(22) Filed: Dec. 15, 2023

Related U.S. Application Data
(63) Continuation of application No. PCT/CN2023/124694, filed on Oct. 16, 2023.

(51) Int. Cl. H04R 7/10; H04R 31/00

(52) U.S. Cl. CPC H04R 7/10; H04R 31/003; H04R 2307/025

(57) ABSTRACT

A composite diaphragm, including an adhesive layer and at least two rubber layers stacked and bound through the adhesive layer. The rubber layer is prepared by crosslinking of a rubber material and a vulcanizing agent, and includes, by weight, 100 parts of ethylene-acrylate rubber, 0-100 parts of nano filler, 1-8 parts of the vulcanizing agent, 0.2-6 parts of an anti-aging agent and 1-10 parts of an internal releasing agent. A sound-generating device including the diaphragm is provided. Through the multi-layer composite structure, the loss factor peak of the composite diaphragm in the dynamic mechanical analysis is widened, and the loss factor is maintained at a higher level within a range from −10° C. to high temperature, greatly improving the damping property. The use of the composite diaphragm in sound-generating devices can effectively improve the acoustic performance and reduce the total harmonic distortion, enabling better acoustic restoration effects.

### CROSS-REFERENCE TO RELATED APPLICATIONS

This application is a continuation of International Patent Application No. PCT/CN2023/124694, filed on Oct. 16, 2023. The content of the aforementioned application, including any intervening amendments made thereto, is incorporated herein by reference in its entirety.

### TECHNICAL FIELD

The present application relates to electroacoustic technology, and more particularly to a composite diaphragm and a sound-generating device utilizing the same.

### BACKGROUND

Sound-generating devices include loudspeakers, headphones, etc., and the diaphragm is an important component of the sound-generating device, which plays a role in improving the sound quality. In the electroacoustic field, the commonly-used diaphragm material is rubber.

In the related technology, rubber is often used as the diaphragm material, and the rubber diaphragm has the characteristics of good pure sound and high loudness, which is highly favored by customers.

However, with the gradual miniaturization of commercial sound-generating devices, the rubber diaphragm cannot further meet the high sound quality requirements due to the characteristics of low damping and high distortion.

Therefore, it is necessary to provide a novel composite diaphragm and a sound-generating device including the same to solve the above technical problems.

### SUMMARY

An object of the present application is to provide a composite diaphragm capable of improving the distortion, and a sound-generating device including the same.

Technical solutions of this application will be specifically described below.

In a first aspect, this application provides a composite diaphragm for a sound-generating device, comprising:
an adhesive layer; and
at least two rubber layers;
wherein adjacent two layers of the at least two rubber layers are stacked, and bound and fixed through the adhesive layer; each of the at least two rubber layers is prepared by high-temperature crosslinking of a rubber material and a vulcanizing agent; and each of the at least two rubber layers comprises:
100 parts by weight of an ethylene-acrylate rubber;
0-100 parts by weight of a nano filler;
1-8 parts by weight of the vulcanizing agent;
0.2-6 parts by weight of an anti-aging agent; and
1-10 parts by weight of an internal releasing agent.

In some embodiments, each of the at least two rubber layers further comprises at least one of styrene-butadiene rubber, natural rubber, acrylate rubber, ethylene-vinyl acetate rubber, nitrile rubber and hydrogenated nitrile rubber.

In some embodiments, the adhesive layer is selected from the group consisting of an organic silicone adhesive, an ultraviolet (UV)-curable adhesive, a hot melt adhesive and a combination thereof.

In some embodiments, the nano filler is selected from the group consisting of carbon black, white carbon black, talcum powder, kaolin, silicon micro-powder, calcium carbonate, clay, montmorillonite and a combination thereof.

In some embodiments, the vulcanizing agent is selected from the group consisting of 1,3,5-triazine-2,4,6-trithiol, a polyamine, an ammonium carboxylate, dithiocarbonate, phthalic anhydride, imidazole, guanidine, sulfur, a peroxide and a combination thereof.

In some embodiments, the anti-aging agent is selected from the group consisting of anti-aging agent 4020, anti-aging agent 3100, anti-aging agent TMQ, anti-aging agent MB, anti-aging agent SP, anti-aging agent 445 and a combination thereof.

In some embodiments, the ethylene-acrylate rubber is mixed with the internal releasing agent, and the internal releasing agent is selected from the group consisting of stearic acid, stearamide, paraffin, methyl silicone oil, polyoxyethylene octadecyl ether phosphate and a combination thereof.

In some embodiments, each of the at least two rubber layers has a thickness of 10-100 μm and a hardness of 10A-80A.

In some embodiments, the adhesive layer has a thickness of 10-100 μm and a glass transition temperature of −50˜50° C.

In some embodiments, a layer structure of the at least two rubber layers is formed by calendering or coating.

In some embodiments, the composite diaphragm is prepared by lamination of the adhesive layer and the at least two rubber layers and hot compression molding.

In a second aspect, this application provides a sound-generating device, including:
the above composite diaphragm.

Compared to the prior art, this application has the following beneficial effects.

The composite diaphragm provided herein includes an adhesive layer and at least two rubber layers, where adjacent rubber layers are stacked, and bound through the adhesive layer. The rubber layer is prepared by crosslinking of a rubber material and a vulcanizing agent. The rubber layer includes 100 parts by weight of an ethylene-acrylate rubber, 0-100 parts by weight of a nano filler, 1-8 parts by weight of the vulcanizing agent, 0.2-6 parts by weight of an anti-aging agent and 1-10 parts by weight of an internal releasing agent. Through the multi-layer composite structure, the loss factor peak of the composite diaphragm in the dynamic mechanical analysis (DMA) is widened, and the loss factor is maintained at a higher level within a range from −10° C. to high temperature, such that the damping property of the diaphragm is greatly improved. The use of the composite diaphragm in the sound-generating device can effectively improve the acoustic performance and reduce the total harmonic distortion, thereby enabling better restoration of acoustic effects.

### BRIEF DESCRIPTION OF THE DRAWINGS

In order to illustrate the technical solutions in the embodiments of the present application more clearly, the drawings needed in the description of embodiments of the present application will be briefly described below. Obviously, presented in the drawings are merely some embodiments of this application, which are not intended to limit this application. For those skilled in the art, other drawings can be obtained based on the drawings provided herein without making creative effort.

FIG. 1 is a structural diagram of a composite diaphragm according to an embodiment of the present disclosure.

FIG. 2 shows dynamic mechanical analysis (DMA) curves of the composite diaphragm according to an embodiment of the present disclosure and a comparative example.

FIG. 3 shows total harmonic distortion (THD) curves of the composite diaphragm according to an embodiment of the present disclosure and the comparative example.

### DETAILED DESCRIPTION OF THE EMBODIMENTS

The present application will be described clearly and completely below with reference to the accompanying drawings and embodiments to make objects, technical solutions, and advantages of the present application clearer and better understood. It should be understood that described below are merely some embodiments of the present application, and are not intended to limit the present application. Other embodiments obtained by those skilled in the art based on the content disclosed herein without making creative effort should fall within the scope of the present application.

### Embodiment 1

This embodiment provides a composite diaphragm for sound-generating devices, which includes an adhesive layer and at least two rubber layers. Adjacent two rubber layers are stacked and bound through the adhesive layer. The rubber layer is prepared by high-temperature crosslinking of a rubber material and a vulcanizing agent. The rubber layer includes 100 parts by weight of an ethylene-acrylate rubber, 0-100 parts by weight of a nano filler, 1-8 parts by weight of the vulcanizing agent, 0.2-6 parts by weight of an anti-aging agent and 1-10 parts by weight of an internal releasing agent.

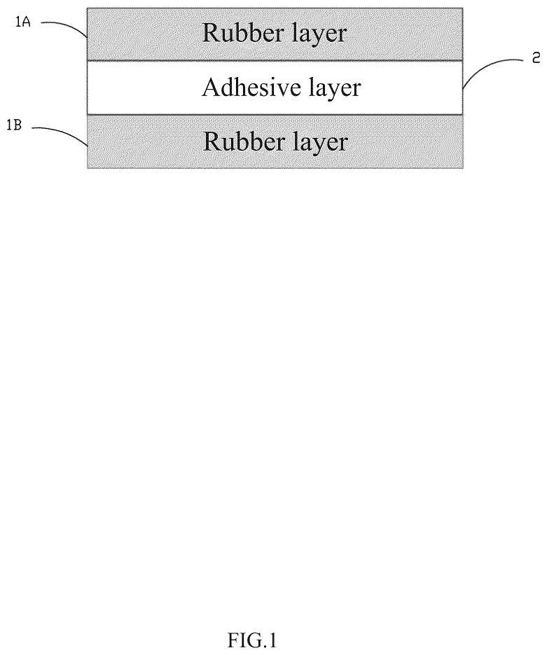

The diaphragm is a composite structure formed by the adhesive layer and the rubber layers, and includes at least two rubber layers and at least one adhesive layer with two sides covered by the rubber layers. FIG. 1 structurally shows the composite diaphragm provided herein, in which a section of the composite diaphragm is presented. The composite diaphragm in FIG. 1 is composed of two rubber layers 1A and 1B, and an adhesive layer 2 with two sides laminated and covered by the two rubber layers. It can be predicted that the diaphragm with the desired thickness can be obtained by increasing the number of rubber layers on the basis of the FIG. 1 and applying the adhesive layer between the rubber layers for lamination.

The rubber layer further includes at least one of styrene-butadiene rubber, natural rubber, acrylate rubber, ethylene-vinyl acetate rubber, nitrile rubber and hydrogenated nitrile rubber.

The adhesive layer is selected from the group consisting of an organic silicone adhesive, an ultraviolet (UV)-curable adhesive, a hot melt adhesive and a combination thereof.

The nano filler is selected from the group consisting of carbon black, white carbon black, talcum powder, kaolin, silicon micro-powder, calcium carbonate, clay, montmorillonite and a combination thereof.

The vulcanizing agent is selected from the group consisting of 1,3,5-triazine-2,4,6-trithiol, a polyamine, an ammonium carboxylate, dithiocarbonate, phthalic anhydride, imidazole, guanidine, sulfur, a peroxide and a combination thereof.

The anti-aging agent is selected from the group consisting of anti-aging agent 4020, anti-aging agent 3100, anti-aging agent TMQ, anti-aging agent MB, anti-aging agent SP, anti-aging agent 445 and a combination thereof.

The ethylene-acrylate rubber is mixed with the internal releasing agent, where the internal releasing agent is selected from the group consisting of stearic acid, stearamide, paraffin, methyl silicone oil, polyoxyethylene octadecyl ether phosphate and a combination thereof.

The rubber layer has a thickness of 10-100 μm and a hardness of 10A-80A.

The adhesive layer has a thickness of 10-100 μm and a glass transition temperature of −50˜50° C.

The rubber layer is prepared by calendering or coating.

The composite diaphragm is prepared by lamination of the adhesive layer and the rubber layers and hot compression molding.

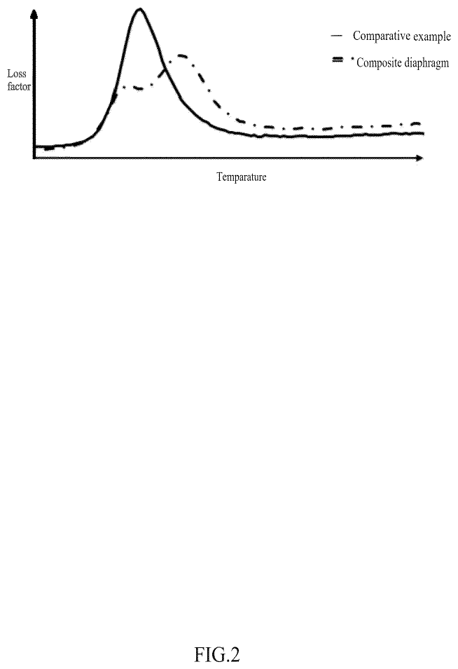

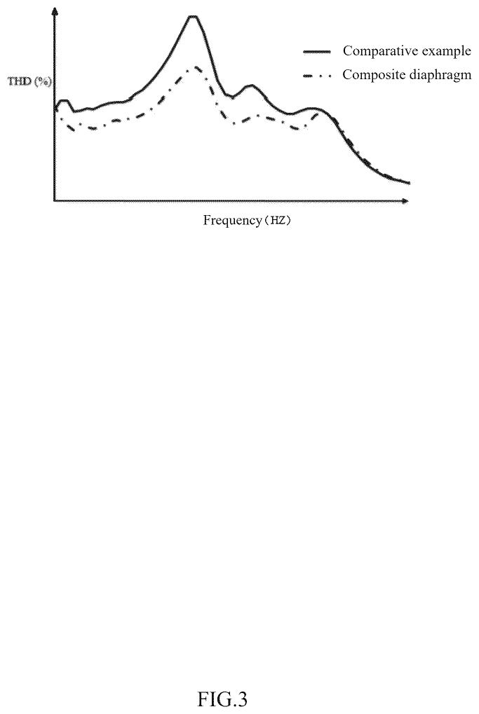

FIG. 2 shows comparison between dynamic mechanical analysis (DMA) curves of the composite diaphragm provided herein and the comparative example (i.e., an ordinary rubber diaphragm), and FIG. 3 shows comparison between total harmonic distortion (THD) curves of the composite diaphragm provided herein and the ordinary rubber diaphragm. It can be observed from FIGS. 2-3 that compared to the comparative example, the composite diaphragm provided herein has a widened loss factor peak in the DMA, and its loss factor is maintained at a higher level within a range from −10° C. to high temperature.

Compared to the prior art, the composite diaphragm provided herein includes an adhesive layer and at least two rubber layers. Adjacent rubber layers are stacked, and bound and fixed through the adhesive layer. The rubber layer is prepared by crosslinking of a rubber material and a vulcanizing agent. The rubber layer includes 100 parts by weight of an ethylene-acrylate rubber, 0-100 parts by weight of a nano filler, 1-8 parts by weight of the vulcanizing agent, 0.2-6 parts by weight of an anti-aging agent and 1-10 parts by weight of an internal releasing agent. Through the multi-layer composite structure, the loss factor peak of the composite diaphragm in the dynamic thermo-mechanical analysis is widened, and the loss factor is maintained at a higher level within a range from −10° C. to high temperature, such that the damping property of the diaphragm is greatly improved. The use of the composite diaphragm in the sound-generating device can effectively improve the acoustic performance and reduce the total harmonic distortion, thereby enabling better restoration of acoustic effects.

### Embodiment 2

This embodiment provides a sound-generating device, which includes the composite diaphragm provided in Embodiment 1. By utilizing the composite diaphragm, the sound-generating device has improved acoustic performance and reduced total harmonic distortion, thereby reaching better restoration of acoustic effects.

It should be understood by those skilled in the art that all or part of the steps of the method described in the above embodiments can be implemented by a hardware under the instruction of a computer program. The program may be stored in a computer-readable storage medium, and is configured to be executed to implement the method described in the above embodiments. The computer-readable storage medium may be a disk, a CD-ROM, a Read-Only Memory (ROM), or a Random Access Memory (RAM).

It should be noted that as used herein, the terms “include”, “comprise”, or any other variations thereof are intended to cover non-exclusive inclusion, such that a process, method, article, or apparatus including a series of elements includes not only those listed elements, but also other elements not expressly listed, or elements inherent to such process, method, article, or apparatus. Unless otherwise specified, the elements defined by the statement “including a . . . ” do not preclude the existence of other identical elements in the process, method, article, or apparatus including said elements.

Through the above description of the embodiments, it is clear to those skilled in the art that the above embodiment method can be implemented with the aid of software in combination of the necessary general-purpose hardware platform, or by means of hardware, but in many cases the former is preferred. Based on this, the technical solutions of the present disclosure essentially or in part contributing to the prior art may be embodied in the form of a software product, and the software product is stored in a storage medium (e.g., ROM/RAM, disk and CD-ROM), and includes a number of instructions to enable a terminal (e.g., a mobile phone, a computer, a server, an air conditioner and a network device) to perform the method described in individual embodiments of the present disclosure.

The foregoing description of the disclosed embodiments enables those of ordinary skill in the art to implement or use the technical solutions of this application, and is not intended to limit the present application. It should be understood that any variations, replacements and modifications made by those of ordinary skill in the art without departing from the spirit and scope of the present application shall fall within the scope of the present application defined by the appended claims.

What is claimed is:

1. A composite diaphragm, comprising:
an adhesive layer; and
at least two rubber layers;
wherein adjacent two layers of the at least two rubber layers are stacked, and bound and fixed through the adhesive layer; each of the at least two rubber layers is prepared by crosslinking of a rubber material and a vulcanizing agent; and each of the at least two rubber layers comprises:
100 parts by weight of an ethylene-acrylate rubber;
0-100 parts by weight of a nano filler;
1-8 parts by weight of the vulcanizing agent;
0.2-6 parts by weight of an anti-aging agent; and
1-10 parts by weight of an internal releasing agent;
wherein the adhesive layer has a thickness of 10-100 μm and a glass transition temperature of −50˜50° C.

2. The composite diaphragm of claim 1, wherein each of the at least two rubber layers further comprises at least one of styrene-butadiene rubber, natural rubber, acrylate rubber, ethylene-vinyl acetate rubber, nitrile rubber and hydrogenated nitrile rubber.

3. The composite diaphragm of claim 1, wherein the adhesive layer is selected from the group consisting of an organic silicone adhesive, an ultraviolet (UV)-curable adhesive, a hot melt adhesive and a combination thereof.

4. The composite diaphragm of claim 1, wherein the nano filler is selected from the group consisting of carbon black, white carbon black, talcum powder, kaolin, silicon micro-powder, calcium carbonate, clay, montmorillonite and a combination thereof.

5. The composite diaphragm of claim 1, wherein the vulcanizing agent is selected from the group consisting of 1,3,5-triazine-2,4,6-trithiol, a polyamine, an ammonium carboxylate, dithiocarbonate, phthalic anhydride, imidazole, guanidine, sulfur, a peroxide and a combination thereof.

6. The composite diaphragm of claim 1, wherein the anti-aging agent is selected from the group consisting of anti-aging agent 4020, anti-aging agent 3100, anti-aging agent TMQ, anti-aging agent MB, anti-aging agent SP, anti-aging agent 445 and a combination thereof.

7. The composite diaphragm of claim 1, wherein the internal releasing agent is selected from the group consisting of stearic acid, stearamide, paraffin, methyl silicone oil, polyoxyethylene octadecyl ether phosphate and a combination thereof.

8. The composite diaphragm of claim 1, wherein each of the at least two rubber layers has a thickness of 10-100 μm and a hardness of 10A-80A.

9. The composite diaphragm of claim 1, wherein a layer structure of the at least two rubber layers is formed by calendering or coating.

10. The composite diaphragm of claim 1, wherein the composite diaphragm is prepared by lamination of the adhesive layer and the at least two rubber layers and hot compression molding.

11. A sound-generating device, comprising:
the composite diaphragm of claim 1.
